(19) United States
(12) Patent Application Publication
(10) Pub. No.: US 2002/0131772 A1
(43) Pub. Date: Sep. 19, 2002

(54) Methods of and devices for transmitting and reproducing audio and/or video information consisting of primary programs and commercials

(76) Inventor: Koen Hendrik Johan Vrielink, Eindhoven (NL)

Correspondence Address: U.S. Philips Corporation, 580 White Plains Road, Tarrytown, NY, 10591, US

(21) Appl. No.: 10/003,057

(22) Filed: Nov. 2, 2001

(30) Foreign Application Priority Data
Nov. 2, 2000 (EP) 00203823.0

(51) Int. Cl. H04N 5/781; H04N 5/85; H04N 7/12; H04N 11/02; H04N 11/04

(52) U.S. Cl. 386/125; 348/385.1; 348/423.1

(57) ABSTRACT

Primary programs (P1, P2, . . . ) and commercials (=secondary programs C1, C2, . . . ) are transmitted alternately and, in the “normal mode” of a display system according to the invention, they are applied directly to a display (3). Tertiary programs (C1*, C2*, . . . ) with commercials are transmitted in parallel and expanded in time, i.e. with a small-bandwidth, and are continuously stored in a memory (4). When the user presses “pause” during the “normal mode”, the tertiary programs (commercials C1*, . . . ) that have been recorded until then will be shown, and the program (P3, . . . ) itself will be delayed, i.e. stored in a buffer (5). When the user resumes watching, he can start with the primary program (P3) where he left off and (some of the) the commercials (C3, C4, . . . ) broadcast at the end of the program will not be shown.

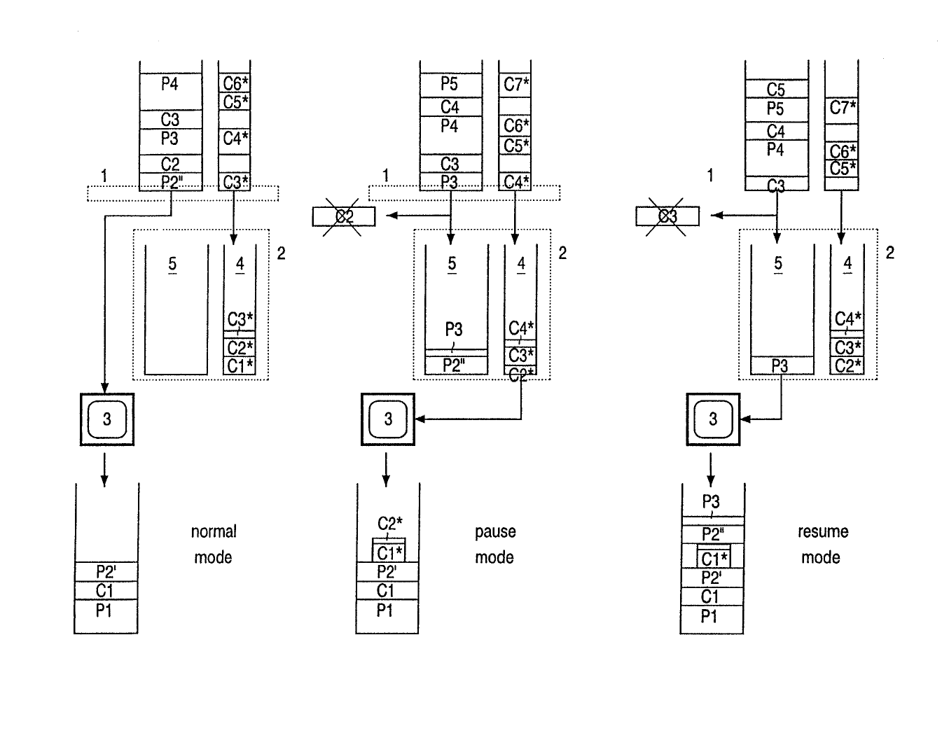

The invention relates to methods of transmitting, receiving, and reproducing audio and/or video information divided into primary and secondary/tertiary programs (commercials), and to a device for carrying out these methods. Moreover, the invention relates to methods of transmitting, receiving, and reproducing audio and/or video information divided into primary and secondary information (commercials), and a device for carrying out these methods.

Information that is broadcast on television or radio may often be divided into primary and secondary information or programs, i.e. connected pieces of information, according to its contents and its relevance to a consumer. Typically, primary information is what the consumer really wants to view or listen to, and secondary information is additional information like commercials, traffic announcements, stock news, weather reports or the like. Primary and secondary information is generally transmitted in an alternating sequence and it is also reproduced in that sequence. This gives the consumer no choice as regards the timing of the secondary information or programs. Therefore, secondary information often appears at unfavourable times.

U.S. Pat. No. 5,333,091 discloses a video cassette recorder (VCR) that may be used to record a transmission. During recording, the VCR tries to detect the start and end of commercials (secondary information) and leaves corresponding time marks on the tape. During playback of the tape, the VCR switches to a fast scan mode from each start of a commercial to its end. The commercial may thus be skipped. However, there is no way to influence the occurrence of commercials online during transmission.

WO 97/36424 discloses a method of displaying advertising information during the time a video channel is changed on a display. The advertising information must be transmitted to the display station in advance and stored there in order to be available at the time a channel is changed.

A display station with a “circular buffer” is disclosed in U.S. Pat. No. 5,371,551. Transmitted audio and/or video information is continuously stored in the buffer and transferred from the buffer to a display. The storage of transmitted information in the buffer enables the user to jump forward an backward in the information to a limited degree, allowing him to skip undesirable secondary information like commercials. However, the application of this procedure requires that the user watches the transmitted information with a certain delay so as to guarantee that the information already stored in the buffer allows a forward jump to be made. Moreover, commercials are totally excluded in this way though they are also of benefit for the consumer, because they can reduce the costs of producing primary programs.

Therefore, it is an object of the present invention to provide a method of and a device for transmitting and reproducing audio and/or video information divided into primary and secondary/tertiary programs (e.g. commercials), in which the timing of the secondary/tertiary programs is better and aimed at the individual consumer.

This object is achieved by methods according to claims 1, 2, 3 and/or 10 and devices according to claims 16, 17, and/or 20.

According to one aspect of the invention, a method of transmitting audio and/or video information is provided, said information being divided into primary, secondary and tertiary programs, the primary and secondary programs being transmitted as usually in an alternating sequence and the tertiary programs being transmitted parallel to the primary and/or secondary programs. Moreover, the invention provides a method of receiving these transmissions. With this method, the information is differentiated into primary, secondary and tertiary programs after reception according to their classification at transmission.

The invention also relates to a method of reproducing audio and/or video information transmitted and received in accordance with the methods mentioned above. The information is divided into primary, secondary and tertiary programs, and the primary and secondary programs are transmitted as usually in an alternating sequence and the tertiary programs are transmitted parallel to the primary and/or secondary programs. During operation, the method switches between the following three modes:

(a) a “normal mode”, in which the primary and secondary programs are reproduced as transmitted, i.e. “in real time”;

(b) a “pause mode” that can be activated by a user at any time; in this mode the reproduction of the primary program is interrupted and tertiary programs are reproduced instead, and currently transmitted and received programs are applied to and stored in a buffer;

(c) a “resume mode” that can be activated by a user at any time during a “pause mode”; in this “resume mode” the storage of currently received programs in the buffer is continued and the reproduction of primary programs is resumed from the instant at which it was interrupted, the primary programs being retrieved from the buffer while any interposed secondary program are left out; the “resume mode” being automatically finished with a return to the “normal mode” if the primary program currently reproduced from buffer ends during the “real time” transmission of the secondary program that follows this primary program in the transmission sequence.

In the “normal mode”, the method simply reproduces the alternating sequence of primary and secondary programs as predetermined by the transmission. The secondary programs may especially consist of commercials. Tertiary programs are received—but not reproduced—parallel to the primary and/or secondary programs. If the user wishes to pause while watching the primary program, e.g. to answer a phone call, he activates the “pause mode”. In the “pause mode” the reproduction of the primary program is interrupted, but nothing of the primary program is lost because it is immediately redirected to a buffer, where it is stored. Instead of the primary program, tertiary programs are displayed. Preferably, the tertiary programs consist of commercials, which in this way reach the consumer at a point of time chosen by the consumer himself.

If the consumer wants to resume watching of the primary program, he deactivates the “pause mode”. This results in a transition to a “resume mode”, in which the reproduction of the tertiary programs is interrupted and the reproduction of the primary program is resumed, from the very instant at which it was interrupted the last time. The primary program is read from the buffer where it was stored since the interruption. Meanwhile, the storage of the incoming transmission of programs is continued, thereby guaranteeing that no information is lost.

In the “resume mode” no secondary programs are reproduced. This exclusion of secondary programs saves time, thus allowing the reproduction of primary programs from the buffer to catch up with the real time transmission of primary and secondary programs. Eventually, a point is reached where the primary program currently reproduced from the buffer ends during the real-time transmission of the secondary program that follows this primary program in the transmission sequence. At this point, a change back to the “normal mode” is effected, and reproduction is continued with the real-time secondary program.

As the secondary programs are reproduced neither in the “pause mode” nor in the “resume mode”, it is preferred that they are not stored in the buffer during these modes, which saves storage capacity.

If the user activates the “pause mode” during the reproduction (and transmission) of a secondary program in the “normal mode”, the reproduction of this secondary program may be continued until the program is finished, after which reproduction of tertiary programs may follow. Alternatively, the reproduction of the secondary program may be interrupted at once and followed by the reproduction of tertiary programs.

Moreover, it is obviously possible to (re)activate the “pause mode” during the “resume mode” without any loss of primary programs.

According to a preferred embodiment of the invention, tertiary programs are transmitted expanded in time, stored in a memory, and reproduced from this memory in the “pause mode”. Moreover, the audio and/or video information is preferably digitally coded. Digital coding makes it possible to transmit a tertiary program of a certain duration over a much longer period of time, i.e. “expanded”. Thus, the tertiary programs can be transmitted parallel to the primary programs and secondary programs, using a small bandwidth only. Due to the expanded transmission, the tertiary programs must be stored in a memory to guarantee that they can be reproduced, if desired, from this memory in real time, i.e. in the “pause mode”.

Of course, the available memory space in the buffer is precious, and therefore parts of the buffer/memory should be designated as free as soon as the programs stored therein have been output and reproduced once. These parts of the buffer/memory can then be used again to store incoming transmissions, i.e. primary/tertiary programs.

According to another embodiment of the invention, the transition from the “pause mode” to the “resume mode” is delayed until the currently reproduced tertiary program ends. In this way it is guaranteed that a tertiary program once started, e.g. a commercial, is finished before the reproduction of the primary program is continued.

The transmission of the primary, secondary, and tertiary programs may originate from any suitable source, e.g. from a recording device like a VCR, or from a broadcast by a radio transmitter. Therefore, it is also possible that an original broadcast by a radio transmitter is first recorded on a VCR or the like and is later transmitted from this device to a display station. In this case, the method according to the invention may be applied both during the original broadcast and during playback from the recording device.

The invention also relates to a method of transmitting and reproducing audio and/or video information transmitted in parallel on several channels, the information in each channel being divided into primary and secondary information. Preferably, the primary information consists of conventional programs which are of primary interest to a user, and the secondary information consists of commercials, which are preferably transmitted parallel to the primary information. The user can select one of said channels, and the primary information of the selected channel is reproduced. Moreover, the method includes an “information mode”, which is initiated each time the user has changed the selected channel, and which is finished a given period of time after initiation, the secondary information being reproduced parallel to or instead of the primary information during the information mode. If the user changes the channel before the end of said period of time, a new information mode is initiated each time.

This method allows the reproduction of additional information, especially advertising information each time that the user has changed a channel. The advertising information may e.g. consist of a message “This program is brought to you by XYZ”. The advertising information thus reaches the user at an instant which is determined by the user himself by changing the channel.

Preferably, the reproduction of the secondary information is started only a given period of time after a change of channels occurred. In this way it is guaranteed that reproduction takes place only if the user has decided to stay at the particular channel for a longer period of time.

According to a preferred embodiment of the method, the secondary information is transmitted parallel to the primary information. It may be expanded in time, stored in a memory, and reproduced from this memory in the information mode. Moreover, the audio and/or video information is preferably digitally coded. Digital coding makes it possible to transmit secondary information of a certain duration over a much longer period of time, i.e. “expanded”. Thus, the secondary information can be transmitted parallel to the primary information, using a small bandwidth only. Due to the expanded transmission, the secondary information must be stored in a memory to guarantee that it can be reproduced from this memory in real time, if desired, i.e. in an information mode.

The transmission of the primary and secondary information may originate from any suitable source, e.g. from a recording device like a VCR, or from a broadcast by a radio transmitter. Therefore, it is also possible that an original broadcast by a radio transmitter is first recorded on a VCR or the like and is later transmitted from this device to a display station. In this case, the method according to the invention may be applied both during the original broadcast and during playback from the recording device.

The methods described above are preferably combined. Thus, in the transmission of primary, secondary, and tertiary programs designated for the implementation of a “pause mode” etc., the secondary and/or tertiary programs preferably serve as secondary information for the implementation of an “information mode”.

Moreover, the invention relates to a receiver for audio and/or video information divided into primary, secondary, and tertiary programs, characterized in that it can receive and discriminate primary and secondary programs transmitted in an alternating sequence and tertiary programs transmitted parallel to the primary and secondary programs.

The invention also relates to a device for the reproduction of audio and/or video information divided into primary, secondary, and tertiary programs, which device includes

(A) a receiver of the above-mentioned type, which can receive and discriminate primary and secondary programs transmitted in an alternating sequence and tertiary programs transmitted parallel to the primary and secondary programs,

(B) a buffer connected to the receiver for the intermediate storage of audio and/or video information,

(C) a reproducing unit connected to the receiver and the buffer for the reproduction of audio and/or video information,

(D) a control unit connected to the receiver, the buffer, and the reproducing unit, which control unit allows switching between the following modes:

(a) a “normal mode”, in which the primary and secondary programs received by the receiver are reproduced as transmitted, i.e. “in real time”;

2(b) a “pause mode”, which can be activated via an input by a user at any time; in this mode the reproduction of the primary program is interrupted and tertiary programs are reproduced instead, currently transmitted programs received by the receiver being applied to and stored in the buffer;

(c) a “resume mode”, which can be activated via an input by a user at any time during a “pause mode”; in this “resume mode” the application and storage of currently transmitted programs received by the receiver to and in the buffer is continued, and the reproduction of primary programs is resumed from the instant at which it was interrupted, the primary programs being retrieved from the buffer while any interposed secondary programs are left out; the “resume mode” being automatically finished with a return to “normal mode” if the primary program currently reproduced from the buffer ends during the “real time” transmission of the secondary program that follows this primary program in the transmission sequence.

This device can implement the first methods described above. Consequently, the advantages resulting from these methods can be achieved. Moreover, the device can be modified in accordance with the preferred variants of the methods described above.

The device may especially include a playback unit which reproduces recorded audio and/or video information divided into primary, secondary, and tertiary programs, the primary and secondary programs being transmitted to the receiver in an alternating sequence and the tertiary programs being transmitted to the receiver parallel to the primary and secondary programs.

Moreover, the invention relates to a device for the reproduction of audio and/or video information transmitted in parallel in a plurality of channels, the information in each channel being divided into primary and secondary information, the device including

(A) a receiver that can receive and discriminate primary and secondary information, the secondary information being preferably transmitted parallel to the primary information,

(B) optionally, a buffer for the intermediate storage of audio and/or video information,

(C) optionally, a decoder that can determine if the secondary information is suited for reproduction after a change of channel,

(D) a reproducing unit connected to the receiver for the reproduction of the audio and/or video information,

(E) a control unit connected to the receiver, buffer, decoder, and the reproducing unit, the control unit allowing a user to select one of a plurality of channels and to apply the primary information of the selected channel from the receiver to the reproducing unit,

the control unit further initiating an information mode each time the selected channel is changed and terminating this information mode a given period of time after initiation, the secondary information being applied to the reproducing unit parallel to or instead of the primary information in the information mode.

This device is capable of implementing the method described above. Consequently, the advantages resulting from this method can be achieved. Moreover, the device can be modified in accordance with the preferred variants of the method described above.

The device may especially include a playback unit that transmits recorded audio and/or video information to the receiver in a plurality of selectable channels, the information in each channel being divided into primary and secondary information.

The invention will now be described by way of example with reference to the accompanying drawing.

The sole FIGURE schematically depicts three stages of operation with different modes (“normal”, “pause”, “resume”) occurring in a device according to the invention for reproducing audio and/or video information by means of a display unit or monitor 3. Instead of a monitor 3 an output could be provided that serves as an interface to another suitable device.

Traditionally, primary programs P1, P2, . . . and commercials (secondary programs) C1, C2, . . . are broadcast alternately, and viewers of a primary program are inevitably confronted with commercials. However, “smart” digital recording devices enable viewers to record or delay a program and skip the commercials very easily. Moreover, the number of channels may be so large and EPGs so powerful that viewers can easily find and tune to another interesting channel. On the other hand, commercials are also interesting for viewers in that they may lead to a reduction of the costs of watching a program. Both viewers and advertising companies benefit if these commercials are well targeted and well timed. A commercial is well timed after a program, before a program, and/or when the viewer indicates he wants to take a break and presses “pause” or “stop” on his TV/VCR/STB (remote) control. Such a timing is achieved with the present invention.

In order to be able to switch to commercials at any time, commercials have to be recorded. Digital broadcast and recording makes it possible to broadcast a 25 second commercial over a much longer period of time using only limited bandwidth. The invention therefore proposes to broadcast commercials C21, C2, . . . in real-time after each program (as is the case traditionally) and commercials C1*, C2*, . . . stretched in time (to save bandwidth) in parallel with the programs. The low-bandwidth time-expanded channel is constantly stored in a memory 4.

The reception of primary and secondary programs P1, P2, . . . C1, C2, . . . in an alternating sequence and the parallel reception of tertiary programs C1*, C2*, . . . is schematically shown in the dotted box that indicates the receiver 1. During “normal mode” (left part of the FIGURE), the primary programs P1 and P2 and the secondary program C1 are applied directly from the receiver 1 to the monitor 3.

The storage unit 2 consists of a memory 4 for the tertiary programs and a buffer 5 for the primary programs. The tertiary programs C1*, C2*, . . . are continuously stored in memory 4.

The operation of the device changes to a “pause mode” (middle part of the FIGURE) when the user presses “pause” (at the instant indicated in the left part of the FIGURE). In the “pause mode” the immediate display of the primary program P2, of which a part P2′ has already been displayed, is interrupted, and the tertiary programs C1*, C2* are displayed instead. To this end, the tertiary programs are retrieved from the memory 4. Meanwhile, the rest P2′ of the primary program P2 and the following primary program P3 are stored in buffer 5. The secondary program C2, however, is not stored in buffer but skipped.

When the user presses “pause” again to indicate that he wants. to continue watching of the primary program P2, the system switches to the “resume mode” (right part of the FIGURE; at the instant indicated in the middle part of the FIGURE). In this mode the display of primary program P2 is resumed, the rest P2′ of this program being retrieved from buffer 5. After this, the following program P3 is also read from the buffer 5. Commercials C2, C3 between these programs are omitted because they have not been stored. This omission of commercials C2, C3 saves time in the real-time transmission and reception of programs and therefore the reproduction of programs from the buffer 5 can finally catch up with the real-time transmission. If this is the case, the system switches back to the “normal mode”.

In summary, it can be stated that if the viewer only views the main program, the commercials after each program will be shown automatically. When the user presses “pause” during the program, the commercials that have been recorded until then will be shown and the program itself will be delayed. When he resumes watching, he can start where he left off and (some of the) the commercials broadcast at the end of the program will not be shown. In other words; he has selected time to watch commercials.

The low bandwidth commercial channel during programs can also be used to insert a small commercial message, which is displayed a short while after the viewer has tuned to the channel (“This program is brought to you by . . . ”). The best timing of this message would be when the viewer decides to watch the program for a longer time. For example, in such a method the tertiary program C1* could be displayed parallel to the primary program P1 after the channel comprising these programs has been selected. Thus, the invention also relates to a method of recognizing secondary/tertiary programs that are suitable for display right after a change in channel or recording. If the program is recorded, the time-expanded commercials can also be recorded, which means that the commercials could be displayed even if the program is viewed after some time or for a second time.

List of references:

| | |
|---|---|
| 1 | receiver |
| 2 | storage unit |
| 3 | display |
| 4 | memory |
| 5 | buffer |
| P1, P2, . . . | primary programs |
| P2′, P2″ | first arid second part of P2 |
| C1, C2, . . . | secondary programs (commercials) |
| C1*, C2*, . . . | tertiary programs (commercials) |

1. A method of transmitting audio and/or video information, characterized in that the information is divided into primary, secondary and tertiary programs, the primary and secondary programs are transmitted in an alternating sequence (P1, C1, P2, C2, . . . ), and the tertiary programs (C1*, . . . ) are transmitted parallel to these programs.

2. A method of receiving audio and/or video information, characterized in that the information is transmitted by means of a method according to claim 1, this information is received, and the received information is differentiated into primary, secondary and tertiary programs.

3. A method of reproducing audio and/or video information transmitted by means of a method according to claim 1 and received by means of a method according to claim 2, which reproducing method switches between the following modes:
(a) a “normal mode”, in which the primary and secondary programs (P1, C1, P2) are reproduced as transmitted;
(b) a “pause mode” that can be activated by a user, in which mode the reproduction of the primary program (P2′) is interrupted and tertiary programs (C1*, C2*) are reproduced instead, and in which any further received primary programs (P2″, P3) are applied to and stored in a buffer (5);
(c) a “resume mode” that can be activated by a user during a “pause mode”, in which “resume mode” the application and storage of received primary programs (P3) to and in the buffer is continued and the reproduction of primary programs (P2″, P3) is resumed from the instant at which it was interrupted, the primary programs being retrieved from buffer while any interposed secondary programs (C2, C3) are left out, the “resume mode” being finished with a return to the “normal mode” if the primary program currently reproduced from buffer ends during the transmission of the secondary program that follows this primary program in the transmission sequence.

4. A method according to one or more of claims 1 to 3, characterized in that the tertiary programs (C1*, C2*, . . . ) are transmitted expanded in time, are stored in a memory (4), and are reproduced from this memory during the “pause mode”.

5. A method according to one or more of claims 3 to 4, characterized in that the secondary programs (C2, C3, . . . ) are not stored in the buffer.

6. A method according to one or more of claims 3 to 5, characterized in that parts of the buffer (5) and/or memory (4) are designated as free as soon as the programs stored therein have been reproduced.

7. A method according to one or more of claims 3 to 6, characterized in that the transition from the “pause mode” to the “resume mode” is delayed until the currently reproduced tertiary program ends.

8. A method according to one or more of the preceding claims, characterized in that the transmission of the primary, secondary, and tertiary programs originates from a recording device like a VCR, or from the broadcast by a radio transmitter.

9. A method according to one or more of the preceding claims, characterized in that the secondary and tertiary programs (C1, . . . , C1* . . . ) comprise commercials.

10. A method of reproducing audio and/or video information transmitted in parallel in a plurality of channels, the information in each channel being divided into primary and secondary information, wherein the user can select one of the channels and the primary information of the selected channel is reproduced, the method including an “information mode”, which is initiated each time the user has changed the selected channel and which is terminated a given period of time after initiation, the secondary information being reproduced parallel to or instead of the primary information during the information mode.

11. A method according to claim 10, characterized in that the secondary information is transmitted parallel to the primary information and preferably expanded in time, is stored in a memory, and is reproduced from this memory during the information mode.

12. A method according to one or more of claims 10 to 11, characterized in that the transmission of the primary and secondary information originates from a recording device like a VCR, or from the broadcasting of a radio transmitter.

13. A method according to one or more of claims 10 to 12, characterized in that the secondary information comprises commercials.

14. A method according to one or more of the claims 10 to 13, characterized in that the audio and/or video information is transmitted according to claim 1 and that the secondary information consists of secondary and/or tertiary programs.

15. A method according to one or more of the preceding claims, characterized in that the audio and/or video information is digitally coded.

16. A receiver for audio and/or video information divided into primary, secondary, and tertiary programs, characterized in that it can receive and discriminate primary and secondary programs (P1, . . . , C1, . . . ) transmitted in an alternating sequence and tertiary programs (C1*, . . . ) transmitted parallel to the primary and secondary programs.

17. A device for reproducing audio and/or video information divided into primary, secondary, and tertiary programs, which device includes
(A) a receiver (1) according to claim 16,
(B) a buffer (5) for the intermediate storage of audio and/or video information,
(C) a reproducing unit (3) for the reproduction of audio and/or video information,
(D) a control unit adapted to allow switching between the following modes:
(a) a “normal mode”, in which the primary and secondary programs (P1, C1, P2) are reproduced as transmitted;
(b) a “pause mode”, which can be activated by a user, in which mode the reproduction of the primary program (P2′) is interrupted and tertiary programs (C1*, C2*) are reproduced instead, and in which any further received primary programs (P2″, P3) are applied to and stored in a buffer (5);
(c) a “resume mode”, which can be activated by a user during a “pause mode”, in which resume mode the application and storage of received primary programs (P3) to and in the buffer is continued and the reproduction of primary programs (P2″, P3) is resumed from the instant at which it was interrupted, the primary programs being retrieved from the buffer while any interposed secondary programs (C2, C3) are left out, the “resume mode” being finished with a return to “normal mode” if the primary program currently reproduced from the buffer ends during the transmission of the secondary program that follows this primary program in the transmission sequence.

18. A device according to claim 17, characterized in that it includes a playback unit which reproduces recorded audio and/or video information divided into primary, secondary, and tertiary programs, the primary and secondary programs (P1, . . . , C1, . . . ) being transmitted to the receiver in an alternating sequence and the tertiary programs (C1*, . . . ) being transmitted to the receiver parallel to the primary and secondary programs.

19. A device according to claim 17 or 18, characterized in that it is adapted to carry out a method according to one of the claims 3 to 9.

20. A device for the reproduction of audio and/or video information transmitted in parallel in a plurality of channels, the information in each channel being divided into primary and secondary information, the device including
(A) a receiver that can receive and discriminate primary and secondary information, the secondary information being preferably transmitted parallel to the primary information,
(B) optionally, a buffer for the intermediate storage of audio and/or video information,
(C) optionally, a decoder that can determine if the secondary information is suited for reproduction after a change of channel,
(D) a reproducing unit for the reproduction of the audio and/or video information,
(E) a control unit that is adapted to allow a user to select one of the plurality of channels and to apply the primary information of the selected channel from the receiver to the reproducing unit,
the control unit further initiating an information mode each time the selected channel is changed and terminating this information mode a given period of time after initiation, the secondary information being applied to the reproducing unit parallel to or instead of the primary information in the information mode.

21. A device according to claim 20, characterized in that it includes a playback unit that transmits recorded audio and/or video information in a plurality of selectable channels, the information in each channel being divided into primary and secondary information.

22. A device according to claim 20 or 21, characterized in that it is adapted to carry out a method according to one of the claims 10 to 14.
